(19) United States
(12) Patent Application Publication
(10) Pub. No.: US 2006/0234846 A1
(43) Pub. Date: Oct. 19, 2006

(54) Tool holder

(75) Inventor: Mark Tucker, Deposit, NY (US)

Correspondence Address: Breiner & Breiner, L.L.C., P.O. Box 19290, Alexandria, VA, 22320-0290, US

(73) Assignee: E-Z RED COMPANY, Deposit, NY (US)

(21) Appl. No.: 11/106,655

(22) Filed: Apr. 15, 2005

(51) Int. Cl. B23Q 3/155

(52) U.S. Cl. 483/26

(57) ABSTRACT

A tool holder having at least one holding member with a fastener to secure at least one tool, such as a wrench or the like, on the tool holder is described. The tool holder has a body and at least one holding member with at least one fastener therein or thereon, wherein the fastener is preferably a magnet. The body is substantially elongated and has a securing member which may be substantially centered along the length of the body. The holding member(s) operatively connect to or about the body, preferably by connecting to or about the securing member of the body. The securing member is preferably a channel or a T-shaped extension member. The holding member(s) may be adjustable along the securing member or permanently fixed to the securing member such as to form a unitary tool holder so that the holding member(s) may accommodate any suitable size tool on the tool holder.

### FIELD OF INVENTION

The present invention relates to a tool holder. More particularly, the present invention relates to a tool holder which utilizes at least one holding member, which may be adjustable or fixed, having at least one fastener to position at least one tool, such as a wrench or the like, on or to the tool holder.

### BACKGROUND OF THE INVENTION

Various types of tools are used by many people in their daily jobs or to repair items and objects around the house or office. These tools are generally stored in a toolbox or in another storage device to keep the tools from being lost, misplaced, broken, damaged or soiled. However, when stored in this manner, the tools may shift position and move around when the tool box is moved or opened, thereby the tools may not be easily and quickly accessible, especially for a person who uses the tools often, but needs the tools out of the way when not in use. Additionally, many tool storage devices do not keep tools organized so that a specific tool can be easily and quickly accessible.

The prior art discloses various devices to hold or position tools. One such device is the Wrench Rack SAE, manufactured by Hansen Global, which is a rack with a base and various predetermined angled slots for holding wrenches by a friction fit design on the sides of the base. The slots of the Wrench Rack SAE are fixed in position and are not adjustable so that only certain size wrenches may be positioned on the slots.

Other devices similar to the Wrench Rack SAE are Wrench Rack 15 Piece manufactured by Protoco, A Wrench Rack SKT1070 manufactured by SK Hand Tools, and Rack For Fan Clutch Wrenches manufactured by Schley Products, Inc.

Also known in the prior art is Coleman, Jr., et al., U.S. Patent Application Publication 2004/0050735 A1, which is said to disclose a magnetic tool holder having a body portion with an elongate central portion defining a channel and having side edges laterally extending from the central portion in a plane. A magnetic member is disposed in the channel and has a tool securing surface positioned in the plane. The base of the holder can be attached through the magnets to a tool box or the like.

Also known is Blick, U.S. Pat. No. 6,431,373 B1, which is said to disclose a support strip for carrying wrench sockets having a base support to which an elongated strip is attached. The elongated strip includes a series of U-shaped tool support members. The support can have a magnet attached to its underside for attaching the strip to a tool cabinet. The support members are not magnetic.

Also known is Stern, U.S. Patent Application Publication 2004/0055917 A1, which is said to disclose an accessory holder for releasably storing tool implements on a portable hand power tool. The holder includes a base strip of durable flexible material. An attachment member is carried by the base strip for releasably attaching the base strip to the tool. An elastic band is carried by the base strip to form a plurality of constricting sleeves for releasably engaging the tool implements. A bit tube is disposed in the constricting sleeves for receiving a tool implement. A restraining magnet is included in the bit tube for magnetically engaging the tool implements in the tube. A utility magnet is carried by the elastic band for magnetically engaging tool implements for temporary storage.

Also known is Winnara, U.S. Pat. Nos. 6,047,824 and 6,073,766, which are said to disclose magnetic tool organizers and tool boxes with magnetic organizers.

Also known is Miller, U.S. Pat. No. 4,544,067, which is said to disclose a magnetic tool holder having a pair of plates with a magnetic bar sandwiched therebetween and a pair of L-shaped support brackets riveted to the assembly for mounting of the device.

Other devices are known for holding tools. These devices, along with the devices above have various shortcomings including only being limited in the size and types of tools to be held, inconvenient to use, and cannot hold a plurality of tools in an organized manner. These and other shortcomings of these devices are addressed by the present invention.

### OBJECTS AND SUMMARY OF THE INVENTION

The present invention relates to a tool holder. More particularly, the present invention relates to a tool holder which has at least one holding member with at least one fastener to secure at least one tool, such as a wrench or the like, on or to the tool holder.

The tool holder of the present invention comprises a body and at least one holding member with at least one fastener. The body is preferably substantially elongated and has a securing member which may be substantially centered along the length of the body. The securing member is preferably fixed on the body. However, the securing member may be adjustable on the body. The at least one holding member operatively connects to the body, such as by operatively connecting or joining to or about the securing member of the body of the tool holder. The holding member is adjustable or fixed along the securing member of the body of the tool holder so that the holding member may accommodate any suitable size tool.

The holding member preferably comprises a first member portion, a second member portion, a projecting member and at least one fastener which may be in or on at least one of the first member portion and/or the second member portion thereof for operatively positioning and affixing a tool, such as a wrench or the like, thereon or thereto. The at least one fastener may be any suitable type or size fastener such as, but not limited to, a magnet, a clamp and/or adhesive. In a preferred embodiment having a magnet as the fastener, a preferred magnet is a neodymium magnet.

The tool holder may comprise a plurality of holding members along the body. Accordingly, the tool holder can retain thereon a plurality of tools of similar or various size.

A primary object of the invention is to provide a tool holder for tools such as wrenches or the like that utilizes adjustable or fixed holding members having fasteners to position the tools thereon.

Another primary object of the invention is to provide a tool holder with a plurality of magnetic holding members which are adjustable or fixed along a length of a body of the tool holder so that the tool holder may accommodate any suitable size tool.

A further primary object of the invention is to provide a tool holder which can hold a plurality of tools and keep those tools out of a work area of a user, but within close reach and easily accessible to the user. For example, the tool holder of the invention may be placed in a tool box having slidable drawers.

Another primary object of the invention is to provide a tool holder which can hold a plurality of tools in an organized manner by being adjustable, wherein the tool holder can be positioned horizontally on a flat surface such as a work table or tool box or vertically on a wall, side of an object, or the like in a work area or location desired by the user.

These primary and other objects of the invention will be apparent from the following description of the preferred embodiments of the invention and from the accompanying drawings.

### BRIEF DESCRIPTION OF THE DRAWINGS

Referring now to the drawings:

FIG. 1 shows a top view of a first embodiment of a tool holder of the present invention in an environment of use, e.g., attached to a flat surface;

FIG. 2 shows a partial exploded perspective view of the tool holder of FIG. 1;

FIG. 3 shows a side view of the tool holder of FIG. 1 in an environment of use, e.g., attached to a flat surface;

FIG. 4 shows a partial cross-sectional side view of a first embodiment of a holding member operatively connected to the body of the tool holder of FIG. 1;

FIG. 5 shows a top plan view of a holding member of the tool holder of FIG. 4 along the line 5-5;

FIG. 6 shows a partial cross-sectional end view of the tool holder of FIG. 1 along the line 6-6 operatively affixed to a flat surface;

FIG. 7 shows a partial exploded perspective view of a second embodiment of the tool holder of the present invention;

FIG. 8 shows a partial cross-sectional side view of a second embodiment of a holding member operatively connected to the body of the tool holder of FIG. 7; and

FIG. 9 shows a top plan view of a holding member of the tool holder of FIG. 8 along the line 9-9.

### DETAILED DESCRIPTION OF THE PREFERRED EMBODIMENTS

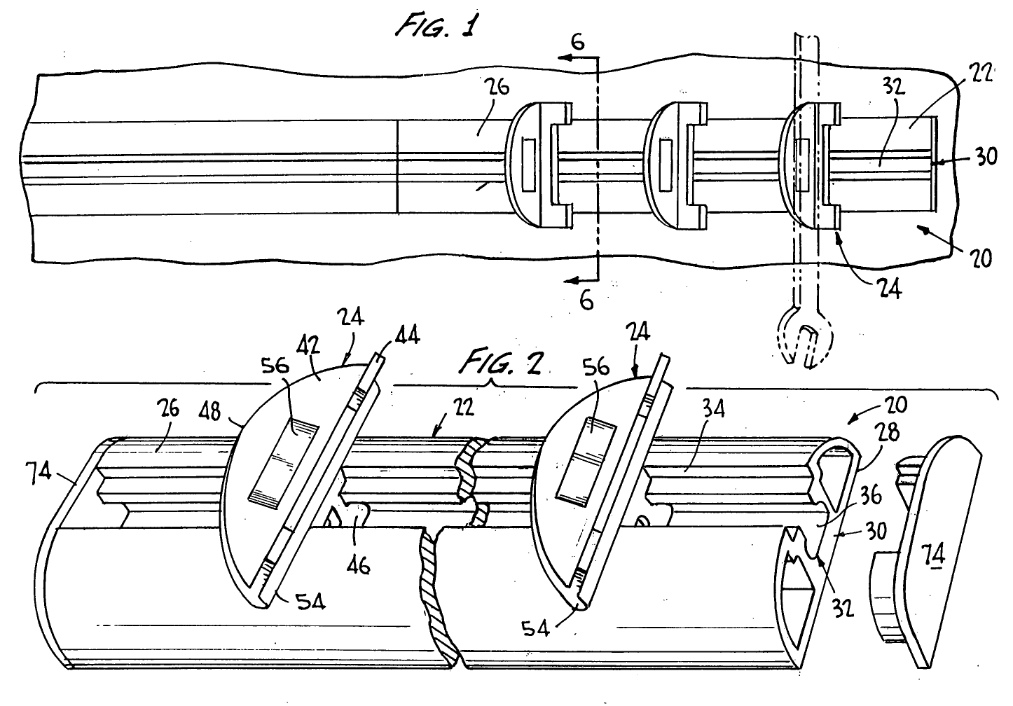

Referring to FIGS. 1-9, the tool holder 20 of the present invention comprises a body 22 and at least one holding member 24,24′ with at least one fastener therein or thereon. The body 22 is preferably substantially elongated and may be horizontally or vertically oriented when in use. A preferred embodiment of the body 22 has a first face 26 and a second face 28. The first face 26 is preferably a rounded or curved face and the second face 28 is preferably a flat face. However, the body 22 may have any suitable number of faces having any suitable shape.

A preferred embodiment of the body 22 has a securing member 30 which may be substantially centered along the length of the body 22 of the tool holder 20. The securing member 30 is used to connect or join at least one holding member 24,24′ to the body 22 of the tool holder 20. In a preferred embodiment, as shown for example in FIGS. 1-4 and 6, the securing member 30 is a channel 32 extruded from the first face 26, e.g., curved face, of the body 22. The channel 32 comprises a base 36 and a top portion 34 extending inwardly. The top portion 34 of the channel 32 may optionally have a plurality of teeth along the sides which extend inwardly. In this embodiment, the holding member 24 connects or joins to the securing member 30 as discussed in greater detail hereafter.

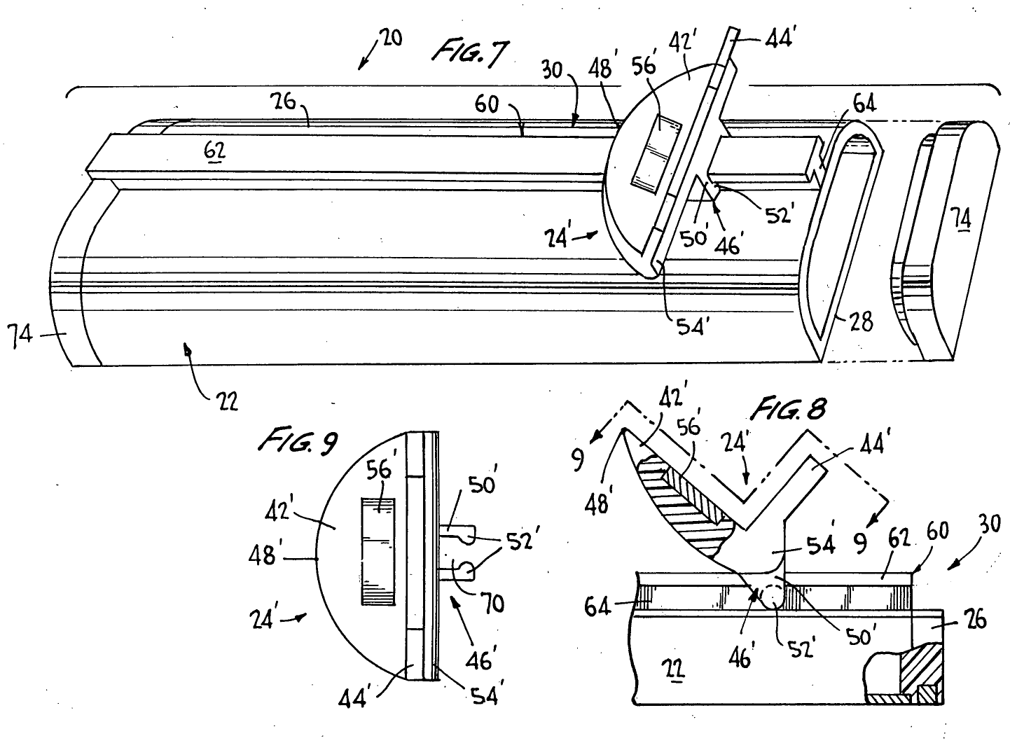

In another preferred embodiment of the tool holder 20, as shown for example in FIGS. 7 and 8, the securing member 30 is a substantially T-shaped extension member 60 which preferably extends outwardly from the first face 26, e.g., curved face, of the body 22. A top end 62 of the extension member 60 preferably has a width greater than a width of a central portion 64 of the extension member 60. In this embodiment, a holding member 24′ connects or joins to the securing member 30 as discussed in greater detail hereafter.

The holding member 24,24′ preferably comprises a first member portion 42,42′, a second member portion 44,44′, a projecting member 46,46′ and a fastener region 56,56′ preferably in or on at least one of the first member portion 42,42′ and/or the second member portion 44,44′. In a preferred embodiment, the first member portion 42,42′ is substantially perpendicular to the second member portion 44,44′. The first member portion 42,42′ and the second member portion 44,44′ may have the same shape or different shapes and may be any suitable shape such as round, curved, spherical, hemispherical, rectangular, square or the like.

In a preferred embodiment, the projecting member 46,46′ is operatively positioned along and extends from a vertex 54,54′ of the first member portion 42,42′ and the second member portion 44,44′ of the holding member 24,24′. The projecting member 46,46′ may preferably be positioned in a substantially central area of the vertex 54,54′. However, the projecting member 46,46′ may be located in any suitable location on the holding member 24,24′. The projecting member 46,46′ operatively connects or joins the holding member 24,24′ to the body 22 of the tool holder 20. More particularly, the projecting member 46,46′ operatively connects or joins the holding member 24,24′ to, within and/or around the securing member 30 of the body 22 of the tool holder 20. The projecting member 46,46′ may be any suitable shape which enables the projecting member 46,46′ to be operatively joined or connected to, within and/or around the securing member 30. The holding member 24,24′ may be adjustable or fixed along the securing member 30 of the body 22 of the tool holder 20 so that the holding member 24,24′ may accommodate or position any suitable size tool.

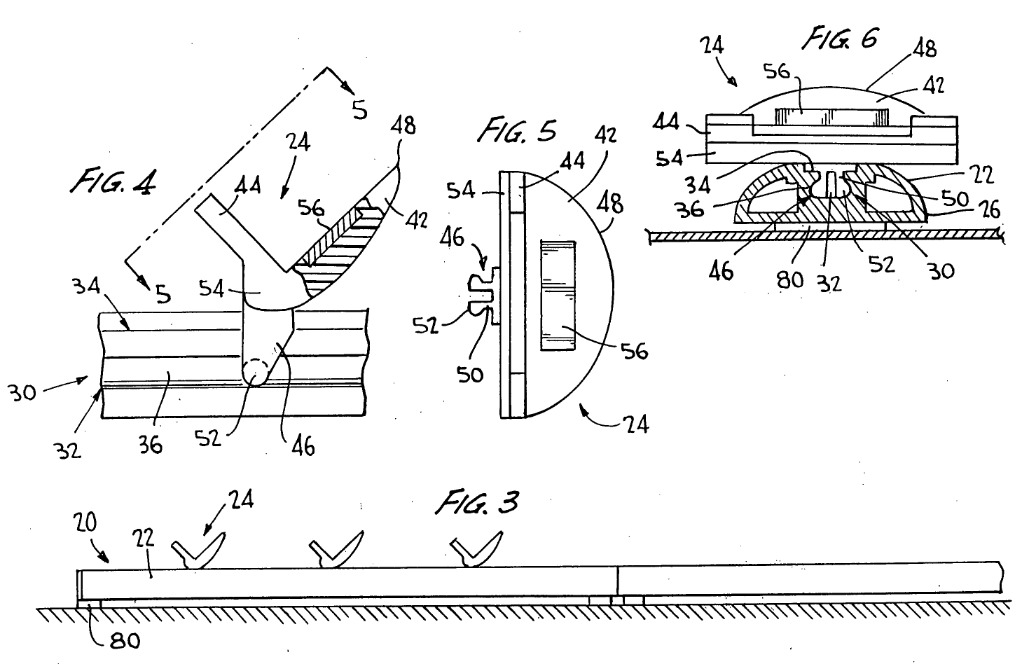

In a preferred embodiment, the projecting member 46,46′ may have at least one, but preferably two extension arms 50,50′, as shown for example in FIGS. 5, 6, 7 and 9. The extension arms 50,50′ may have outward protrusions 52, as shown for example in FIGS. 4-6, or inward protrusions 52′, as shown for example in FIGS. 7-9.

In an embodiment where the securing member 30 of the body 22 of the tool holder 20 is a channel 32, as described above, the extension arms 50 of the projecting member 46 of the holding member 24 have outward protrusions 52, as shown for example in FIGS. 4-6. The outward protrusions 52 of the extension arms 50 are of a suitable size and shape to enable the outward protrusions 52 of the extension arms 50 of the projecting member 46 to be operatively positioned within the base 36 of the channel 32 of the body 22.

In an embodiment where the securing member 30 of the body 22 of the tool holder 20 is a substantially T-shaped extension member 60, as described above, the extension arms 50′ of the projecting member 46′ of the holding member 24′ have inward protrusions 52′, as shown for example in FIGS. 7-9. The inward protrusions 52′ of the extension arms 50′ are of a suitable size and shape to enable the inward protrusions 52′ of the extension arms 50′ of the projecting member 46′ to be operatively positioned around the top end 62 and substantially adjacent to the outer sides of the central portion 64 of the extension member 60 of the body 22. Accordingly, the top end 62 of the extension member 60 is operatively positioned within a cavity 70 defined or formed in the projecting member 46′ by the extension arms 50′ and the inward protrusions 52′, as shown for example in FIG. 9.

The fastener region 56,56′ preferably operatively positioned in or on at least one of the first member portion 42,42′ and/or the second member portion 44,44′ of the holding member 24,24′ has at least one magnet, clamp, adhesive or the like. The fastener region 56,56′ enables a tool, such as a wrench or the like, to be operatively positioned and/or secured to or retained on the first member portion 42,42′ and/or the second member portion 44,44′ of the holding member 24,24′. However, the fastener region 56,56′ is preferably at least one magnet. The at least one magnet may be any suitable type and size magnet, but a preferred magnet is a neodymium magnet having the following dimensions: 1″ L×⅜″ W×⅛″ H.

In a preferred embodiment, the tool holder 20 comprises a plurality of holding members 24,24′ positioned along the body 22. Accordingly, the tool holder 20 can retain thereon a plurality of tools of similar or various size.

The holding member 24,24′ may be joined or connected to the body 22 of the tool holder 20 by any suitable means. However, in a preferred embodiment, the holding member 24,24′ joins or connects to the body 22 of the tool holder 20 by aligning the holding member 24,24′ substantially with the body 22 and operatively positioning the projecting member 46,46′ of the holding member 24,24′ into or onto the securing member 30 of the body 22.

As shown for example in FIG. 6, in an embodiment of the invention where the securing member 30 is a channel 32 and the extension arms 50 of the projecting member 46 have outward protrusions 52, the holding member 24 is preferably aligned substantially parallel with the body 22 and the projecting member 46 is operatively positioned within the channel 32. The holding member 24 is then preferably rotated such that the holding member 24 is substantially perpendicular to and adjacent to the body 22 of the tool holder 20. For example, the holding member 24 is preferably rotated about 90° such that the holding member 24, e.g., vertex 54 thereof, is substantially perpendicular to and adjacent to the body 22, e.g., the channel 32 of the body 22. In this position, the outward protrusions 52 of the extension arms 50 of the projecting member 46 are positioned within the base 36 of the channel 32 such that the holding member 24 is substantially positioned for receiving a tool. The holding member 24 may be adjusted along the length of the channel 32 by exerting an upward and/or outward force or pressure on the free end 48 of the first member portion 42 of the holding member 24 such that the projecting member 46 is movable within the channel 32. The holding member 24 may then be adjusted along the length of the channel 32 of the body 22 to any suitable position. When the upward and/or outward force or pressure on the free end 48 of the first member portion 42 is removed, the holding member 24 is fixed in position for receiving a tool. Any suitable number of holding members 24 may be secured to the body 22 of the tool holder 20 as described above.

As shown for example in FIGS. 7 and 8, in an embodiment of the invention where the securing member 30 is a substantially T-shaped extension member 60 and the extension arms 50′ of the projecting member 46′ have inward protrusions 52′, the holding member 24′ is preferably aligned substantially perpendicular with the body 22 and the projecting member 46′ is operatively positioned adjacent to and around the T-shaped extension member 60 of the body 22. For example, the inward protrusions 52′ of the holding member 24′ are operatively positioned around the top end 62 and substantially adjacent to the outer sides of the central portion 64 of the extension member 60 of the body 22 of the tool holder 20. Accordingly, the top end 62 of the extension member 60 is operatively positioned within the cavity 70 defined by or formed in the projecting member 46′ by the extension arms 50′ and the inward protrusions 52′.

In this position, the inward protrusions 52′ of the projecting member 46′ are positioned around the central portion 64 of the extension member 60 such that the holding member 24′ is substantially positioned for receiving a tool. The holding member 24′ may be adjusted along the length of the extension member 60 by exerting an upward and/or outward force or pressure on the free end 48′ of the first member portion 42′ of the holding member 24′ such that the projecting member 46′ is movable along the extension member 60. The holding member 24′ may then be adjusted along the length of the extension member 60 of the body 22 to any suitable position. When the upward and/or outward force or pressure on the free end 48′ of the first member portion 42′ is removed, the holding member 24′ is substantially fixed in position for receiving a tool. Any suitable number of holding members 24′ may be joined or connected to the body 22 of the tool holder 20 as described above.

The body 22 of the tool holder 20 of the present invention may optionally have end caps 74 on each end of the body 22, as shown for example in FIGS. 2 and 7. The end caps 74 may be removable or integral with the body 22. The end caps 74 preferably provide an aesthetic aspect to the body 22 of the tool holder 20.

Two or more tool holders 20 of the present invention may be linked together or arranged in series so as to accommodate a plurality of tools, such as shown for example in FIGS. 1 and 3.

Any suitable attaching means 80, number and arrangement thereof, may be used to position the tool holder 20 on a flat surface such as in a tool drawer, on top of a work bench, on a wall, a top or side of an object or the like, in an environment of use. In a preferred embodiment, the attaching means 80 are magnets operatively positioned on the second face 28 of the body 22 or on the back face of the end caps 74 of the tool holder 20. The tool holder 20 may then be positioned in any suitable location and on any suitable metallic object. However, other suitable attaching means 80, such as, but not limited to, screws, nails, bolts, wire, adhesive or the like may be used to position the tool holder 20 in a suitable location on a metallic or nonmetallic surface.

The tool holder 20 of the present invention and components thereof may be made of any suitable material including, but not limited to, metal, plastic, combination of materials, or the like.

While the tool holder 20 is described in terms of holding a wrench (shown in phantom lines in FIG. 1), the tool holder may hold any other suitable tools.

In an alternative embodiment of the tool holder 20 of the present invention, at least one holding member 24,24′ is permanently fixed to the securing member 30 of the body 22 or to the body 22 itself.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A tool holder comprising:
a body; and
at least one holding member adjoining to said body, wherein said at least one holding member has at least one fastener,
wherein each said at least one fastener may position or connect a tool to each said at least one holding member.

2. The tool holder according to claim 1, wherein said body comprises a first face, a second face and a securing member along a length of said first face of said body, and
wherein said at least one holding member joins said body by said securing member.

3. The tool holder according to claim 2, wherein said securing member is a channel in said first face of said body, said channel having a base and a top end extending inwardly.

4. The tool holder according to claim 3, wherein said at least one holding member comprises a first member portion, a second member portion and a projecting member, wherein said first member portion and said second member portion are substantially perpendicular, wherein said projecting member is located along a vertex of said first member portion and said second member portion, and wherein said at least one fastener is located in or on at least one of said first or second member portions of said holding member.

5. The tool holder according to claim 1, wherein said at least one holding member comprises a first member portion, a second member portion and a projecting member, wherein said first member portion and said second member portion are substantially perpendicular, wherein said projecting member is located along a vertex of said first member portion and said second member portion, and wherein said at least one fastener is located in or on at least one of said first or second member portions of said at least one holding member.

6. The tool holder according to claim 5, wherein said projecting member comprises a first extension arm and a second extension arm.

7. The tool holder according to claim 6, wherein said at least one holding member joins said body by a securing member along a length of said body, wherein said securing member is a channel on a first face of said body.

8. The tool holder according to claim 7, wherein said projecting member further comprises an outward protrusion on a free end of each of said first extension arm and said second extension arm, wherein each said outward protrusion is positioned within a base of said channel, thereby joining said at least one holding member to said body.

9. The tool holder according to claim 2, wherein said at least one holding member is adjustable or fixed along a length of said securing member.

10. The tool holder according to claim 3, wherein said at least one holding member is adjustable or fixed along a length of said channel.

11. The tool holder according to claim 2, wherein said securing member is a substantially T-shaped extension member extending outwardly from said first face of said body, said T-shaped extension member comprising a top end and a central portion, wherein said top end has a width greater than a width of said central portion of said T-shaped extension member.

12. The tool holder according to claim 6, wherein said projecting member further comprises an inward protrusion on a free end of each said first extension arm and said second extension arm, wherein a cavity is defined by said first extension arm, said second extension arm, and each said inward protrusion,
wherein said first extension arm and said second extension arm are substantially parallel.

13. The tool holder according to claim 12, wherein said at least one holding member joins said body by a securing member along a length of said body, wherein said securing member is a substantially T-shaped extension member extending outwardly from a first face of said body, said T-shaped extension member comprising a top end and a central portion, wherein said top end has a width greater than a width of said central portion of said T-shaped extension member.

14. The tool holder according to claim 13, wherein said first extension arm and said second extension arm are positioned outside of said top end of said extension member and said inward protrusions are substantially adjacent to an outer side of said central portion of said extension member of said body, wherein said top end of said extension member is positioned within said cavity of said projecting member, thereby joining said at least one holding member to said body.

15. The tool holder according to claim 11, wherein said at least one holding member is adjustable or fixed along a length of said T-shaped extension member.

16. The tool holder according to claim 1, wherein said at least one fastener includes one of a magnet, a clamp or an adhesive.

17. The tool holder according to claim 1, wherein said at least one fastener is a neodymium magnet.

18. The tool holder according to claim 2, wherein said first face of said body is a substantially curved and elongated face and said second face of said body is a substantially flat and elongated face.

19. The tool holder according to claim 1, wherein said at least one holding member is adjustable or fixed along a length of said body.

20. A tool holder comprising:
a substantially elongated body having a substantially curved first face, a substantially flat second face, and a securing member along a length of said first face;
a plurality of holding members joined to said body by said securing member, wherein said plurality of holding members are adjustable or fixed along a length of said securing member; and
at least one magnet positioned in or on each said plurality of holding members,
wherein each said at least one magnet may position or connect a tool on each said plurality of holding members.

21. The tool holder according to claim 20, wherein said securing member is a channel on said first face of said body or a substantially T-shaped extension member extending outwardly from said first face of said body.

22. The tool holder according to claim 20, wherein each said plurality of holding members comprise a first member portion, a second member portion and a projecting member, wherein said first member portion and said second member portion are substantially perpendicular, wherein said projecting member is located along a vertex of said first member portion and said second member portion, and wherein said at least one magnet is located in or on at least one of said first or second member portions of said holding member, wherein said projecting member comprises a first extension arm and a second extension arm and a protrusion on a free end of each of said first extension arm and said second extension arm.

23. The tool holder according to claim 22, wherein said securing member is a channel, wherein each said protrusion is an outward protrusion, wherein each said outward protrusion of said first and second extension arms is secured within a base of said channel, thereby securing said at least one holding member to said body.

24. The tool holder according to claim 22, wherein said securing member is a substantially T-shaped extension member extending outwardly from said first face of said body, said T-shaped extension member comprising a top end and a central portion, wherein each said protrusion is an inward protrusion thereby forming a cavity, wherein said first extension arm and said second extension arm are positioned outside of said top end of said T-shaped extension member and said inward protrusions are substantially adjacent to an outer side of said central portion of said T-shaped extension member of said body, wherein said top end of said T-shaped extension member is secured within said cavity, thereby securing said at least one holding member to said body.
